(19) United States
(12) Patent Application Publication
(10) Pub. No.: US 2012/0064424 A1
(43) Pub. Date: Mar. 15, 2012

(54) LOW COST METHOD AND SIGNAL PROCESSING ALGORITHM TO RAPIDLY DETECT ABNORMAL OPERATION OF AN INDIVIDUAL FUEL CELL IN A PLURALITY OF SERIES CONNECTED FUEL CELLS

(75) Inventors: ROBERT L. FUSS, SPENCERPORT, NY (US); CLARK G. HOCHGRAF, HONEOYE FALLS, NY (US); MATTHEW K. HORTOP, BRAUNSCHWEIG (DE)

(73) Assignee: GM GLOBAL TECHNOLOGY OPERATIONS, INC., Detroit, MI (US)

(21) Appl. No.: 12/882,983

(22) Filed: Sep. 15, 2010

(51) Int. Cl. H01M 8/04

(52) U.S. Cl. 429/431

(57) ABSTRACT

A system and method for determining reactant gas flow through a fuel cell stack to determine potential stack problems, such as a possible low performing fuel cell. The method includes applying a perturbation frequency to the fuel cell stack and measuring the stack current and stack voltage in response thereto. The measured voltage and current are used to determine an impedance of the stack fuel cells, which can then be compared to a predetermined fuel cell impedance for normal stack operation. If an abnormal fuel cell impedance is detected, then the fuel cell system can take corrective action that will address the potential problem.

### BACKGROUND OF THE INVENTION

1. Field of the Invention

This invention relates generally to a system and method for determining reactant gas flows in a fuel cell stack and, more particularly, to a system and method for identifying undesirable reactant gas flows in a fuel cell stack by applying a perturbation frequency to the fuel cell stack, measuring the stack current and stack voltage in response thereto and using the current and voltage measurements to determine the real and complex fuel cell impedance.

2. Discussion of the Related Art

Hydrogen is a very attractive fuel because it is clean and can be used to efficiently produce electricity in a fuel cell. A hydrogen fuel cell is an electro-chemical device that includes an anode and a cathode with an electrolyte therebetween. The anode receives hydrogen gas and the cathode receives oxygen or air. The hydrogen gas is dissociated in the anode to generate free protons and electrons. The protons pass through the electrolyte to the cathode. The protons react with the oxygen and the electrons in the cathode to generate water. The electrons from the anode cannot pass through the electrolyte, and thus are directed through a load to perform work before being sent to the cathode.

Proton exchange membrane fuel cells (PEMFC) are a popular fuel cell for vehicles. The PEMFC generally includes a solid polymer electrolyte proton conducting membrane, such as a perfluorosulfonic acid membrane. The anode and cathode typically include finely divided catalytic particles, usually platinum (Pt), supported on carbon particles and mixed with an ionomer. The catalytic mixture is deposited on opposing sides of the membrane. The combination of the anode catalytic mixture, the cathode catalytic mixture and the membrane define a membrane electrode assembly (MEA). MEAs are relatively expensive to manufacture and require certain conditions for effective operation.

Several fuel cells are typically combined in a fuel cell stack by serial coupling to generate the desired power. For example, a typical fuel cell stack for a vehicle may have two hundred or more stacked fuel cells. The fuel cell stack receives a cathode input reactant gas, typically a flow of air forced through the stack by a compressor. Not all of the oxygen is consumed by the stack and some of the air is output as a cathode exhaust gas that may include water as a stack by-product. The fuel cell stack also receives an anode hydrogen reactant gas that flows into the anode side of the stack. The stack also includes flow channels through which a cooling fluid flows.

The fuel cell stack includes a series of bipolar plates positioned between the several MEAs in the stack, where the bipolar plates and the MEAs are positioned between the two end plates. The bipolar plates include an anode side and a cathode side for adjacent fuel cells in the stack. Anode gas flow channels are provided on the anode side of the bipolar plates that allow the anode reactant gas to flow to the respective MEA. Cathode gas flow channels are provided on the cathode side of the bipolar plates that allow the cathode reactant gas to flow to the respective MEA. One end plate includes anode gas flow channels, and the other end plate includes cathode gas flow channels. The bipolar plates and end plates are made of a conductive material, such as stainless steel or a conductive composite. The end plates conduct the electricity generated by the fuel cells out of the stack. The bipolar plates also include flow channels through which a cooling fluid flows.

As a fuel cell stack ages, the performance of the individual cells in the stack degrade differently as a result of various factors. There are different causes of low performing cells, such as cell flooding, loss of catalyst, etc., some temporary and some permanent, some requiring maintenance, and some requiring stack replacement to exchange those low performing cells. Although the fuel cells are electrically coupled in series, the voltage of each cell when a load is coupled across the stack decreases differently where those cells that are low performing have lower voltages. Thus, it is necessary to monitor the cell voltages of the fuel cells in a stack to ensure that the voltages of the cells do not drop below a predetermined threshold voltage to prevent cell voltage polarity reversal, possibly causing permanent damage to the cell.

Typically, the voltage output of every fuel cell in the fuel cell stack is monitored so that the system knows if a fuel cell voltage is too low, indicating a possible failure. As is understood in the art, because all of the fuel cells are electrically coupled in series, if one fuel cell in the stack fails, then the entire stack will fail. Certain remedial actions can be taken for a failing fuel cell as a temporary solution until the fuel cell vehicle can be serviced, such as increasing the flow of hydrogen and/or increasing the cathode stoichiometry.

Fuel cell voltages are often measured by a cell voltage monitoring sub-system that includes an electrical connection to each bipolar plate, or some number of bipolar plates, in the stack and end plates of the stack to measure a voltage potential between the positive and negative sides of each cell. Therefore, a 400 cell stack may include 401 wires connected to the stack. Because of the size of the parts, the tolerances of the parts, the number of the parts, etc., it may be impractical to provide a physical connection to every bipolar plate in a stack with this many fuel cells, and the number of parts increases the cost and reduces the reliability of the system.

A total harmonic distortion (THD) of the fuel cell stack voltage can also be measured and used as a cell voltage detection signal. Typically, however, this method is not reliable as it does not produce a consistent signal, where it may be producing an increasing THD under some conditions, a decreasing THD under other conditions or no change in the THD under other conditions.

### SUMMARY OF THE INVENTION

In accordance with the teachings of the present invention, a system and method for determining reactant gas flow through a fuel cell stack are disclosed to determine potential stack problems, such as a possible low performing fuel cell. The method includes applying a perturbation frequency to the fuel cell stack and measuring the stack current and stack voltage in response thereto. The measured voltage and current are used to determine the real and complex impedance of the stack fuel cells, which can then be compared to predetermined fuel cell impedance or ratio of impedances for normal stack operation. If an abnormal fuel cell impedance is detected, then the fuel cell system can take corrective action that will address the potential problem.

Additional features of the present invention will become apparent from the following description and appended claims, taken in conjunction with the accompanying drawings.

### BRIEF DESCRIPTION OF THE DRAWINGS

FIG. 1 is a block flow diagram of a fuel cell system that measures reactant gas flow through a fuel cell stack; and

FIG. 2 is a schematic diagram of a circuit for applying a perturbation frequency to a fuel cell stack and measuring the voltage and current on the stack.

### DETAILED DESCRIPTION OF THE EMBODIMENTS

The following discussion of the embodiments of the invention directed to a system and method for monitoring reactant gas flow in a fuel cell stack to determine stack abnormalities is merely exemplary in nature, and is in no way intended to limit the invention or its applications or uses.

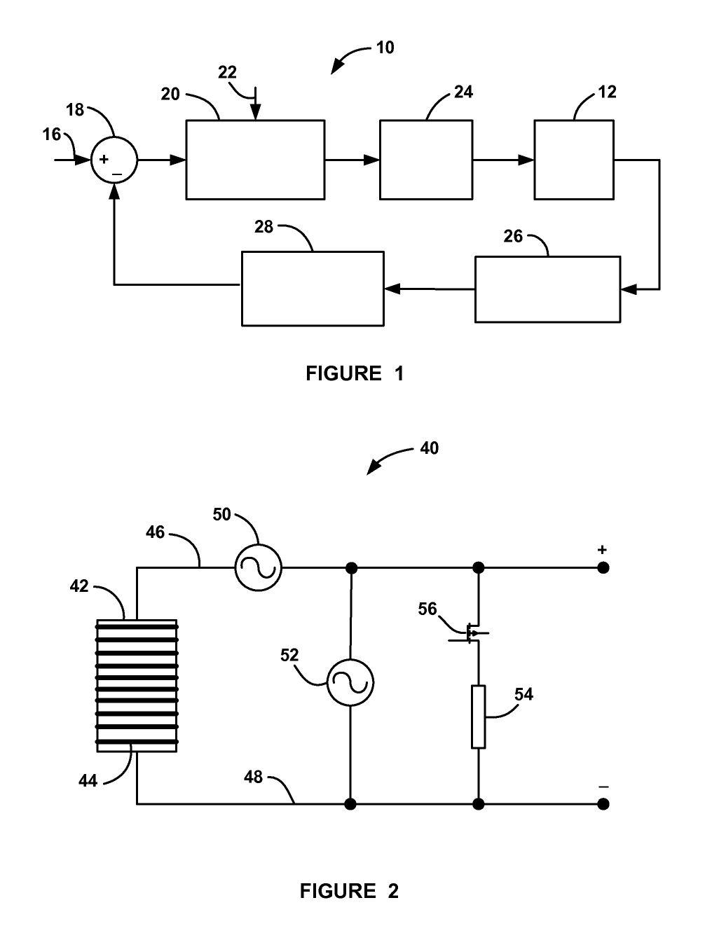

FIG. 1 is a block flow diagram for a fuel cell system 10 including a fuel cell stack 12. In the system 10, predetermined desirable spectral measurements, including desired stack voltage, stack current, fuel cell impedance, etc., for optimal stack and system operation is provided on line 16 to a summation junction 18. These measurements and parameters are sent to a reactant control algorithm at box 20 that also receives a reactant flow request on line 22 for a desired stack output power, such as vehicle throttle position. The reactant control algorithm determines the proper reactant gas flow including both the air flow for the cathode side of the fuel cell stack 12 and the hydrogen gas flow for the anode side of the fuel cell stack 12. The reactant control algorithm uses the reactant request signal and the desired measurements for the optimal system operation to determine how much reactant flow should be provided to the stack 12 in a manner that is well understood to those skilled in the art. Control signals provided by the algorithm at the box 20 are then sent to a reactant flow box 24 that represents the control for a compressor that provides cathode air to the cathode side of the stack 12 and a hydrogen fuel source that provides hydrogen gas to the anode side of the fuel cell stack, such as an injector or injector bank providing hydrogen gas from a high pressure storage tank.

As will be discussed in detail below, a perturbation frequency is applied to the stack 12 to determine fuel cell impedance, which can be an indication of proper reactant gas flow for both the cathode side and anode side of the fuel cell stack 12. A different frequency would be required to detect the flow through the anode and cathode sides of the stack 12. The reason that a different frequency is needed for the cathode side and the anode side of the fuel cell stack 12 has to do with the catalyst configuration at the electrodes of the MEAs in the fuel cells. The perturbation frequency will be a relatively low frequency, depending on the particular flow being determined. The particular frequency would depend on the stack technology being used, and would typically be determined experimentally. For current stack technologies, a frequency signal in the 2-5 Hz range may be applicable for hydrogen gas flow through the anode side of the fuel cell stack 12 and a frequency signal of about 50 Hz may be applicable for the air flow through the cathode side of the fuel cell stack 12.

Spectral measurements of the fuel cell stack 12 are provided at box 26, which represents a voltage meter that measures the voltage across the stack 12, or at least a series of fuel cells in the stack 12, and a current meter that measures the current flow through the stack 12 or the current flow through a series of the fuel cells in the stack 12. The voltage and the current measurements from the box 26 are provided to an impedance calculation algorithm at box 28 that uses those measurements to calculate the real and complex impedance of the cells in the stack 12 or the group of series connected cells being measured. The impedance calculation algorithm uses the calculated impedance and, depending on whether it is the cathode air or the anode hydrogen gas being monitored, determines whether the calculated impedance is the optimal impedance by a comparison process, or ratio of impedances, for the fuel cells at the current system operating conditions. If the impedance of the fuel cells is not the desired impedance for those operating conditions, then the impedance calculation algorithm sends a signal to the summation junction 18 to adjust the desired spectral measurements on the line 16 so that the reactant control algorithm at the box 20 changes the reactant flow at the box 24. The reactant control algorithm will know which of the cathode or the anode side of the fuel cell stack 12 is currently being monitored and will for that time adjust only one or the other of the compressor or the hydrogen gas injectors, if necessary.

In addition, the system controller can take other remedial or corrective actions to improve the cell impedance, such as adjusting the humidification of the cathode inlet air, adjusting the coolant flow through and/or temperature of the fuel cell stack 12, reducing the stack load current, etc. Thus, in this manner, the system 10 is able to monitor cell voltages to detect abnormal operating conditions with only two connections to the fuel cell stack 12 for the voltage meter and the current meter, instead of the many connections that were typically required to measure fuel cell voltages to detect low performing cells.

In addition to detecting abnormal or improper system operating conditions, the system and method discussed herein can be used to trim or minimize the cathode air flow and the hydrogen gas flow to the fuel cell stack 12. Particularly, by identifying the minimum cathode air flow and/or anode gas flow to the stack 12 for the current stack power request or load, determining the cell impedance in the manner as discussed above can be used to ensure that this minimal flow is being achieved for efficient system operation. Thus, the compressor speed can be minimized and the amount of hydrogen provided at the stack 12 can be minimized for efficient operation.

FIG. 2 is a schematic diagram of a system 40 for applying a perturbation frequency to a fuel cell stack 42 including a plurality of series connected fuel cells 44, as discussed above. A positive electrical line 46 is coupled to a positive end of the fuel cell stack 42 and a negative electrical line 48 is coupled to a negative end of the fuel cell stack 42, where the lines 46 and 48 provide the stack power to the particular system being powered. A current meter 50 is provided on the positive line 46 to measure the current flow through the stack 42 and a voltage meter 52 is electrically coupled across the lines 46 and 48 to measure the voltage potential across the stack 42.

The present invention contemplates any suitable technique for providing the perturbation frequency to the stack 42 for determining cell impedance in the manner as discussed above. In this non-limiting embodiment, the system 40 includes a load 54 having a certain resonate frequency, such as a suitable resistor, and a MOSFET switch 56 electrically coupled to the lines 46 and 48 across the stack 42, as shown. When power is being provided by the stack 42, the switch 56 is opened and closed at the desired frequency, i.e., the resonate frequency of the load 54, so that an AC frequency signal is applied to the stack 42 on top of the DC power signal provided by the stack 12. The voltage across the stack 42 and the current through the stack 42 are measured at the frequencies that the switch 56 is opened and closed. These measurements are used to determine both the real and reactive impedance of the cells 44 in the stack 42 in a manner that is well understood to those skilled in the art. The measurement of the voltage and current at the frequencies that the switch 56 is opened and closed to determine cell impedance has to do with the electrodes in the MEAs discharging as a capacitance when the switch 56 is opened. Further, each different catalyst material would provide a different cell impedance. When the cathode airflow is being determined, then the switch 56 is opened and closed at one desirable frequency and when the anode fuel flow is being determined, the switch 56 is opened and closed at a different frequency. In an alternate embodiment, the switch 56 may be some device that is able to provide both the cathode frequency and the anode frequency simultaneously.

In the discussion above, the perturbation frequency was provided by elements that were added to the system for that particular purpose. In alternate designs, the load 54 may be an existing component in the fuel cell system 10, such as end cell heaters, power converters, DC/DC boost converters, etc.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for monitoring a fuel cell stack including a plurality of series connected fuel cells, said method comprising:
applying a frequency signal to the fuel cell stack;
measuring the voltage across the fuel cell stack;
measuring a current through the fuel cell stack;
calculating a real and complex impedance of the fuel cells using the measured voltage and the measured current; and
comparing the calculated impedance of the fuel cells to an optimal fuel cell impedance to determine fuel cell stack characteristics.

2. The method according to claim 1 wherein applying the frequency signal to the fuel cell stack includes selecting the frequency signal for a cathode side of the fuel cell stack having a first frequency or selecting the frequency signal for an anode side of the fuel cell stack having a second frequency where the first and second frequencies are different.

3. The method according to claim 2 wherein the first frequency is about 50 Hz and the second frequency is about 2-5 Hz.

4. The method according to claim 1 further comprising taking corrective action if the difference between the calculated fuel cell impedance and the optimal fuel cell impedance is greater than a predetermined threshold.

5. The method according to claim 4 wherein taking corrective action includes increasing or decreasing an airflow to the cathode side of the fuel cell stack and/or increasing or decreasing a hydrogen gas flow to an anode side of the fuel cell stack.

6. The method according to claim 4 wherein taking a corrective action includes changing the humidification of a cathode airflow to the fuel cell stack, adjusting a cooling fluid flow to the fuel cell stack or reducing a load current on the fuel cell stack.

7. The method according to claim 1 wherein applying a frequency signal to the fuel cell stack includes selectively connecting and disconnecting a load across the fuel cell stack.

8. The method according to claim 7 wherein the load is a resistor and selectively connecting and disconnecting the resistor is provided by a switch.

9. The method according to claim 7 wherein the load is an element in the fuel cell stack used for other purposes.

10. The method according to claim 9 wherein the element is a power converter.

11. The method according to claim 1 wherein determining fuel cell stack characteristics includes determining cathode and anode flows through the stack.

12. A method for monitoring reactant gas flows through a fuel cell stack including a plurality of series connected fuel cells, said method comprising:
applying a frequency signal having a first frequency to the fuel cell stack by selectively connecting and disconnecting a load across the stack to monitor an air flow through a cathode side of the fuel cell stack;
applying a frequency signal having a second frequency to the fuel cell stack by selectively connecting and disconnecting a load across the stack to monitor a hydrogen gas flow through an anode side of the fuel cell stack, where the first and second frequencies are different;
measuring the voltage across the fuel cell stack as the frequency signal is being applied;
measuring a current through the fuel cell stack as the frequency signal is being applied;
calculating a real and complex impedance of the fuel cells using the measured voltage and the measured current; and
comparing the calculated impedance of the fuel cells to an optimal fuel cell impedance to determine whether the reactant gas flow is optimal for the current stack operating conditions.

13. The method according to claim 12 further comprising taking corrective action if the difference between the calculated fuel cell impedance and the optimal fuel cell impedance is greater than a predetermined threshold.

14. The method according to claim 13 wherein taking corrective action includes increasing or decreasing the airflow to the cathode side of the fuel cell stack and/or increasing or decreasing the hydrogen gas flow to an anode side of the fuel cell stack.

15. The method according to claim 12 wherein the load is a resistor and selectively connecting and disconnecting the resistor is provided by a switch.

16. The method according to claim 12 wherein the load is an element in the fuel cell stack used for other purposes.

17. The method according to claim 12 wherein the element is a power converter.

18. The method according to claim 12 wherein the first frequency is about 50 Hz and the second frequency is about 2-5 Hz.

19. A system for monitoring reactant gas flows through a fuel cell stack including a plurality of series connected fuel cells, said system comprising:
means for applying a frequency signal having a first frequency to the fuel cell stack by selectively connecting and disconnecting a load across the stack to monitor an air flow through a cathode side of the fuel cell stack;
means for applying a frequency signal having a second frequency to the fuel cell stack by selectively connecting and disconnecting a load across the stack to monitor a hydrogen gas flow through an anode side of the fuel cell stack, where the first and second frequencies are different;
means for measuring the voltage across the fuel cell stack as the frequency signal is being applied;
means for measuring a current through the fuel cell stack as the frequency signal is being applied;
means for calculating a real and complex impedance of the fuel cells using the measured voltage and the measured current;
means for calculating a ratio of calculated impedance values; and
means for comparing the ratio of calculated impedance of the fuel cells to an optimal fuel cell impedance to determine whether the reactant gas flow is optimal for the current stack operating conditions.

20. The system according to claim 19 wherein the load is a resistor and selectively connecting and disconnecting the resistor is provided by a switch.

21. The system according to claim 19 wherein the load is a power converter.

22. The system according to claim 19 further comprising means for taking corrective action if the difference between the calculated real and complex fuel cell impedance and the optimal fuel cell impedance is greater than a predetermined threshold, wherein the means for taking corrective action increases or decreases the airflow to the cathode side of the fuel cell stack and/or increases or decreases the hydrogen gas flow to an anode side of the fuel cell stack.

23. The system according to claim 19 wherein the first frequency is about 50 Hz and the second frequency is about 2-5 Hz.
